(19) United States
(12) Patent Application Publication
(10) Pub. No.: US 2007/0100647 A1
(43) Pub. Date: May 3, 2007

(54) Eligibility list management in a distributed group membership system

(75) Inventors: Eliezer Dekel, Haifa (IL); Gera Goft, Pardes Hanah-Carcur (IL); Yoel Krasny, Tel Aviv (IL); Alexander Krits, Haifa (IL); Dean Lorenz, Haifa (IL); William T. Newport, Rochester, MN (US); James W. Stopyro, Rochester, MN (US); Alan J. Wecker, Misgav (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/268,267

(22) Filed: Nov. 3, 2005

(51) Int. Cl. G06Q 99/00

(52) U.S. Cl. 705/1

(57) ABSTRACT

A method for eligibility list management in a distributed group membership system, including receiving an eligibility list change request with respect to an eligibility list of a group of computing elements, removing from a view of the group any active members in the group who are to be removed from the eligibility list as indicated by the eligibility list change request, preventing any of the members that are removed from the view from rejoining a view until the eligibility list change is applied to the eligibility list, applying the eligibility list change to the eligibility list, and establishing a new view for any active members in the group who are on the changed eligibility list.

### FIELD OF THE INVENTION

The present invention relates to distributed computing in general, and more particularly to distributed group membership services therefor.

### BACKGROUND OF THE INVENTION

Groups of distributed computers and/or computer processes, that cooperate to perform a task or set of tasks are often managed using a distributed group membership system (GMS). The GMS typically maintains an eligibility list indicating which computers or processes may join the group. GMSs typically maintain their eligibility lists as either a fixed list or as a dynamic list. GMSs that maintain dynamic eligibility lists accommodate changes to the membership more easily than GMSs that maintain fixed eligibility lists, while GMSs that maintain fixed eligibility lists allow for quorums to be more easily determined and better support algorithms which are based on how many of the potential members are active within the group.

### SUMMARY OF THE INVENTION

The present invention discloses a system and method for managing eligibility lists in a distributed group membership system. Fixed eligibility list management techniques are adapted to allow dynamic changes to the eligibility list which are then propagated to all members in the view, as well as to new members who join the view.

In one aspect of the present invention a method is provided for eligibility list management in a distributed group membership system, the method including receiving an eligibility list change request with respect to an eligibility list of a group of computing elements, removing from a view of the group any active members in the group who are to be removed from the eligibility list as indicated by the eligibility list change request, preventing any of the members that are removed from the view from rejoining a view until the eligibility list change is applied to the eligibility list, applying the eligibility list change to the eligibility list, and establishing a new view for any active members in the group who are on the changed eligibility list.

In another aspect of the present invention the receiving step includes receiving where the eligibility list change request is a request to add a member to the eligibility list.

In another aspect of the present invention the receiving step includes receiving where the eligibility list change request is a request to remove a member from the eligibility list.

In another aspect of the present invention the removing step includes removing from a plurality of copies of the view.

In another aspect of the present invention the applying step includes applying to a plurality of copies of the eligibility list.

In another aspect of the present invention the method further includes relaying the eligibility list change request to a plurality of GMS agents associated with the computing elements. In another aspect of the present invention further includes receiving a connection request from any of the computing elements to join the group, initiating an unknown member connection attempt event within the group membership system if the requester is not on the eligibility list, authenticating the requestor, and initiating the eligibility list change request to add the authenticated requestor to the eligibility list.

In another aspect of the present invention a distributed group membership system with eligibility list management is provided, the system including a plurality of computing elements operative to become active members in a group of the computing elements, and a plurality of group membership system (GMS) agents, each agent being associated with one of the computing elements and operative to maintain a copy of a group eligibility list which indicates which of the computing elements may join the group receive an eligibility list change request with respect to the eligibility list, remove from a view of the group any active members in the group who are to be removed from the eligibility list as indicated by the eligibility list change request, prevent any of the members that are removed from the view from rejoining any view of the group until the eligibility list change is applied to the eligibility list, apply the eligibility list change to the eligibility list, and establish a new view for any active members in the group who are on the changed eligibility list.

In another aspect of the present invention the computing elements are operative to cooperate in a distributed fashion to perform one or more tasks as part of a cooperative mission.

In another aspect of the present invention the agents are operative to cooperate with other of the GMS agents to collectively provide a distributed GMS with distributed management regarding the membership of the computing elements in the group.

In another aspect of the present invention the group eligibility list indicates which of the computing elements may join the group view of active group members who are available to assist in carrying out the cooperative mission.

In another aspect of the present invention the agents are operative to maintains a copy of the same group view.

In another aspect of the present invention the change request is a request to add a member to the eligibility list.

In another aspect of the present invention the change request is a request to remove a member from the eligibility list.

In another aspect of the present invention the agents are operative to remove the active members from a plurality of copies of the view.

In another aspect of the present invention the agents are operative to apply the eligibility list change to a plurality of copies of the eligibility list.

In another aspect of the present invention the agents are operative to relay the eligibility list change request to the plurality of GMS agents associated with the computing elements.

In another aspect of the present invention the agents are operative to receive a connection request from any of the computing elements to join the group, initiate an unknown member connection attempt event within the group membership system if the requestor is not on the eligibility list, authenticate the requester, and initiate the eligibility list change request to add the authenticated requester to the eligibility list.

In another aspect of the present invention a computer-implemented program is provided embodied on a computer-readable medium, the computer program including a first code segment operative to receive an eligibility list change request with respect to an eligibility list of a group of computing elements, a second code segment operative to remove from a view of the group any active members in the group who are to be removed from the eligibility list as indicated by the eligibility list change request, a third code segment operative to prevent any of the members that are removed from the view from rejoining a view until the eligibility list change is applied to the eligibility list, a fourth code segment operative to apply the eligibility list change to the eligibility list, and a fifth code segment operative to establish a new view for any active members in the group who are on the changed eligibility list.

In another aspect of the present invention the receiving code segment includes receiving where the eligibility list change request is a request to add a member to the eligibility list.

In another aspect of the present invention the receiving code segment includes receiving where the eligibility list change request is a request to remove a member from the eligibility list.

In another aspect of the present invention the removing code segment includes removing from a plurality of copies of the view.

In another aspect of the present invention the applying code segment includes applying to a plurality of copies of the eligibility list.

In another aspect of the present invention further includes a sixth code segment operative to relay the eligibility list change request to a plurality of GMS agents associated with the computing elements.

In another aspect of the present invention the computer-implemented program further includes a seventh code segment operative to receiving a connection request from any of the computing elements to join the group, a eighth code segment operative to initiating an unknown member connection attempt event within the group membership system if the requestor is not on the eligibility list, a ninth code segment operative to authenticating the requester, and a tenth code segment operative to initiating the eligibility list change request to add the authenticated requestor to the eligibility list.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a distributed group membership system (GMS) supporting a distributed computing system, constructed and operative in accordance with a preferred embodiment of the present invention;

FIG. 2 is a simplified flowchart illustration of a method for eligibility list management in a distributed group membership system, operative in accordance with a preferred embodiment of the present invention; and

FIG. 3 which is a simplified flowchart illustration of a method for eligibility list management in a distributed group membership system, operative in accordance with a preferred embodiment of the present invention.

### DETAILED DESCRIPTION OF PREFERRED EMBODIMENTS

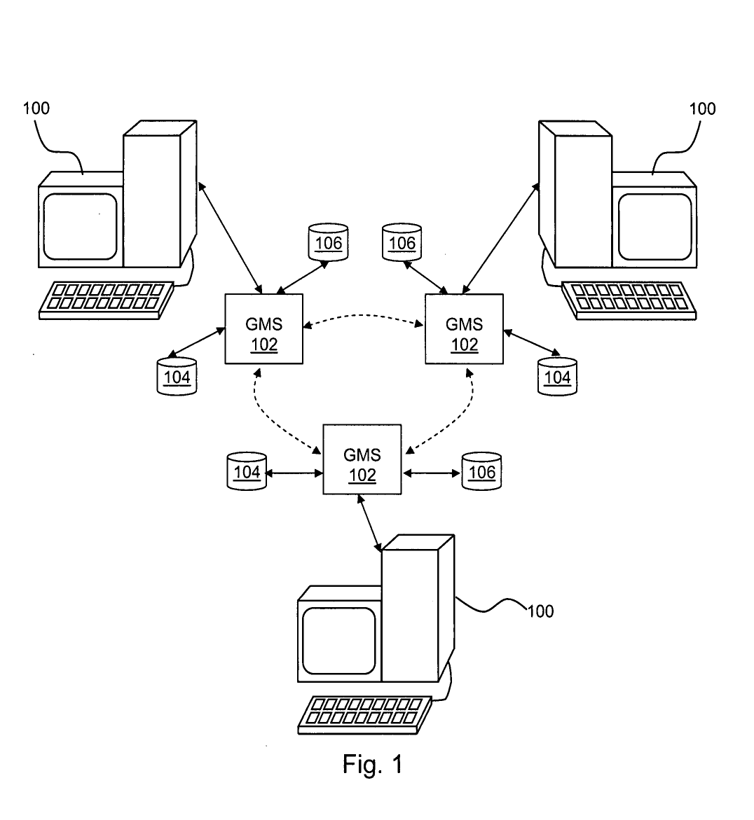

Reference is now made to FIG. 1, which is a simplified conceptual illustration of a distributed group membership system (GMS) supporting a distributed computing system, constructed and operative in accordance with a preferred embodiment of the present invention. In the system of FIG. 1, multiple computing elements 100, each representing a computer or a computer process, cooperate with one another in a distributed fashion to perform one or more tasks as part of a cooperative mission. Each element 100 includes a GMS agent 102 which cooperates with other GMS agents 102 to collectively provide a distributed GMS with distributed management regarding the membership of elements 100 in a group formed by elements 100. Each GMS agent 102 typically maintains a copy of a group eligibility list 104 which indicates which elements 100 may join a group view 106 of active group members who are available to assist in carrying out the cooperative mission, where each GMS agent 102 also typically maintains a copy of the same group view 106. GMS agents 102 operate in accordance with conventional group membership management techniques except as described herein.

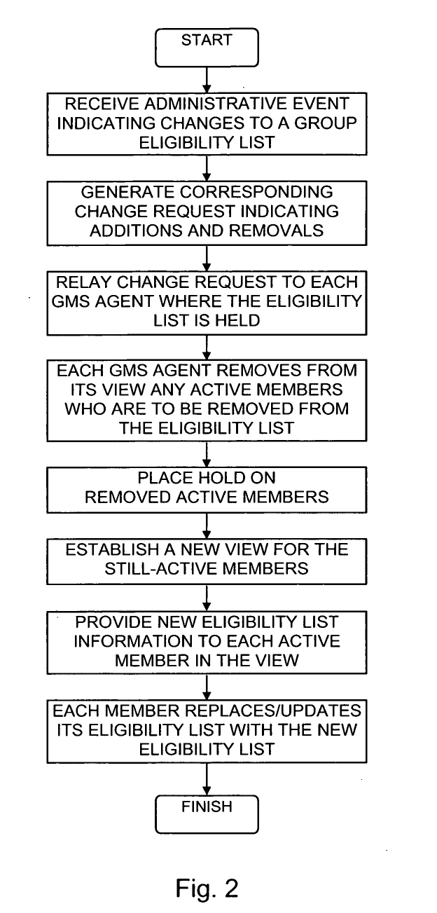

Reference is now made to FIG. 2 which is a simplified flowchart illustration of a method for eligibility list management in a distributed group membership system, operative in accordance with a preferred embodiment of the present invention. In the method of FIG. 2, given an administrative event where a change is to be made to a group eligibility list held by a group of computing elements, such as where an element is to be added to or removed from the group eligibility list, a corresponding change request is generated indicating the additions and removals. The change request may be generated by a source external to the membership, and is relayed to each GMS agent where the eligibility list is held. The change request typically includes a list of the eligible members that are to comprise the new eligibility list after additions and removals are made. After receiving the change request, each GMS agent removes from its copy of the group view any currently active members in the view who are to be removed from the eligibility list. A “hold” is preferably placed on those active members that are removed from the view to indicate that they may not rejoin the view until the “hold” is removed. A new view is then established for the still-active members using conventional techniques. If it hasn't already been done as part of the change request propagation, the new eligibility list information is provided to each active member in the view. Each member then replaces its eligibility list with the new eligibility list or updates its eligibility list according to the new eligibility list information.

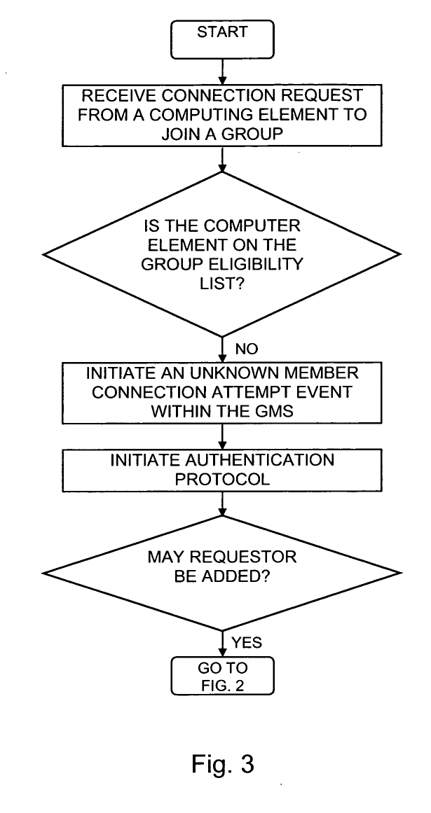

Reference is now made to FIG. 3 which is a simplified flowchart illustration of a method for eligibility list management in a distributed group membership system, operative in accordance with a preferred embodiment of the present invention. In the method of FIG. 3, when there is a connection request from a computing element to join a group where the computer element is not on the group eligibility list, the group member receiving the connection request may initiate an UnknownMemberConnectionAttempt event within the GMS. An authentication protocol may then be initiated, using any authentication technique, to determine if the requestor should be added to the group eligibility list. If the requestor may be added, the method of FIG. 2 may be followed.

Computing elements that are added to the group eligibility list may be sent a message including the current group eligibility list when they first attempt to join a group or, alternatively, after their next attempt. Where a newly added member to the group eligibility list receives a connection request from another list member before it has updated its copy of the group eligibility list, the connection request may be handled as described above as a connection request from an unknown member.

Aspects of the methods of FIGS. 2 and 3 may be demonstrated in the context of the following exemplary session where a computing element ‘N’ attempts to join an existing group whose eligible members are (A,B,C,D) as follows:
1. N obtains basic configuration information (e.g., name, IP address) for the group and for itself
2. N knows at least one member (B) that is in the group view and in the main partition. Thus, N's Group Eligibility List (GEL) is (BN)
3. N attempts a connection to B, and sends its current GEL (BN) to B
4. B, whose current GEL is (A,B,C,D), rejects N's attempt, and initiates an UnknownMemberConnectionAttempt event within its GMS agent
5. The GMS authenticates N and initiates procedures on B's current view to add N to the GEL, such as by executing an AddDefinedMember(N) call on B, where the instruction to add N is distributed to all of B's current view members who then update their GEL accordingly
6. B sends a copy of its GEL (ABCDN) to N
7. All existing view members add N to their GEL copy, which is now (ABCDN)
8. All existing view members may attempt connections to N, who is in their GEL, but not yet in their view
9. N initiates a second connection attempt to B, and sends its current GEL (BN)
10. B accepts the connection and sends a copy of its GEL (ABCDN) to N
11. A attempts a connection to N (who did not yet receive B's message of step 6
12. N rejects the connection attempt from the unknown member A, and initiates an UnknownMemberConnectionAttempt event within its GMS
13. N's GMS authenticates A and initiates procedures on N's current view (N) to add A to N's GEL (similar to step 5) and N updates its GEL to (ABN)
14. N receives B's GEL (ABCDN), as sent on step 6, and raises an event indicating a conflict with its own GEL of (ABN)
15. N's GMS agent initiates procedures on N's current view (N) to add missing group members (CD) to its view (which is (N) at this point), and N updates its GEL to (ABCDN)
16. All view members and N have the same GEL (ABCDN) now, hence they and can merge.
17. D, that was down and out of the view did not get the update GEL message, tries to connect to A and sends its current GEL (ABCD) to A
18. A does not merge with D, as it has a conflicting GEL; but, since D is in A's GEL, A sends its own updated GEL (ABCDN) to D
19. D receives A's updated GEL (ABCDN) and raises an event indicating a conflict with its own GEL to its local system, which initiates procedures on D's current view (D) to add missing group members (N) on D
20. All have a consistent GEL, hence can merge

It is appreciated that some of the events described above may occur in a different order than that shown or in parallel.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for eligibility list management in a distributed group membership system, the method comprising:
receiving an eligibility list change request with respect to an eligibility list of a group of computing elements;
removing from a view of said group any active members in said group who are to be removed from said eligibility list as indicated by said eligibility list change request;
preventing any of said members that are removed from said view from rejoining a view until said eligibility list change is applied to said eligibility list;
applying said eligibility list change to said eligibility list; and
establishing a new view for any active members in said group who are on said changed eligibility list.

2. A method according to claim 1 wherein said receiving step comprises receiving where said eligibility list change request is a request to add a member to said eligibility list.

3. A method according to claim 1 wherein said receiving step comprises receiving where said eligibility list change request is a request to remove a member from said eligibility list.

4. A method according to claim 1 wherein said removing step comprises removing from a plurality of copies of said view.

5. A method according to claim 1 wherein said applying step comprises applying to a plurality of copies of said eligibility list.

6. A method according to claim 1 and further comprising relaying said eligibility list change request to a plurality of GMS agents associated with said computing elements.

7. A method according to claim 1 and further comprising:
receiving a connection request from any of said computing elements to join said group;
initiating an unknown member connection attempt event within said group membership system if said requestor is not on said eligibility list;
authenticating said requestor; and
initiating said eligibility list change request to add said authenticated requestor to said eligibility list.

8. A distributed group membership system with eligibility list management, the system comprising:
a plurality of computing elements operative to become active members in a group of said computing elements; and
a plurality of group membership system (GMS) agents, each agent being associated with one of said computing elements and operative to:
maintain a copy of a group eligibility list which indicates which of said computing elements may join said group
receive an eligibility list change request with respect to said eligibility list,
remove from a view of said group any active members in said group who are to be removed from said eligibility list as indicated by said eligibility list change request,
prevent any of said members that are removed from said view from rejoining any view of said group until said eligibility list change is applied to said eligibility list,
apply said eligibility list change to said eligibility list, and
establish a new view for any active members in said group who are on said changed eligibility list.

9. A system according to claim 8 wherein said computing elements are operative to cooperate in a distributed fashion to perform one or more tasks as part of a cooperative mission.

10. A system according to claim 8 wherein said agents are operative to cooperate with other of said GMS agents to collectively provide a distributed GMS with distributed management regarding the membership of said computing elements in said group.

11. A system according to claim 9 wherein said group eligibility list indicates which of said computing elements may join said group view of active group members who are available to assist in carrying out said cooperative mission.

12. A system according to claim 8 wherein said agents are operative to maintains a copy of the same group view.

13. A system according to claim 8 wherein said change request is a request to add a member to said eligibility list.

14. A system according to claim 8 wherein said change request is a request to remove a member from said eligibility list.

15. A system according to claim 8 wherein said agents are operative to remove said active members from a plurality of copies of said view.

16. A system according to claim 8 wherein said agents are operative to apply said eligibility list change to a plurality of copies of said eligibility list.

17. A system according to claim 8 wherein said agents are operative to relay said eligibility list change request to said plurality of GMS agents associated with said computing elements.

18. A system according to claim 8 wherein said agents are operative to:
receive a connection request from any of said computing elements to join said group;
initiate an unknown member connection attempt event within said group membership system if said requester is not on said eligibility list;
authenticate said requestor; and
initiate said eligibility list change request to add said authenticated requestor to said eligibility list.

19. A computer-implemented program embodied on a computer-readable medium, the computer program comprising:
a first code segment operative to receive an eligibility list change request with respect to an eligibility list of a group of computing elements;
a second code segment operative to remove from a view of said group any active members in said group who are to be removed from said eligibility list as indicated by said eligibility list change request;
a third code segment operative to prevent any of said members that are removed from said view from rejoining a view until said eligibility list change is applied to said eligibility list;
a fourth code segment operative to apply said eligibility list change to said eligibility list; and
a fifth code segment operative to establish a new view for any active members in said group who are on said changed eligibility list.

20. A computer-implemented program according to claim 19 wherein said receiving code segment comprises receiving where said eligibility list change request is a request to add a member to said eligibility list.
